(19) United States
(12) Patent Application Publication
(10) Pub. No.: US 2025/0278061 A1
(43) Pub. Date: Sep. 4, 2025

(54) ELECTRONIC TIMEPIECE, HAND POSITION DETECTION METHOD, AND STORAGE MEDIUM

(71) Applicant: CASIO COMPUTER CO., LTD., Tokyo (JP)

(72) Inventors: Yuta SAITO, Tokyo (JP); Tomohiro INABA, Tokyo (JP); Youhei KAWAGUCHI, Tokyo (JP); Fumiaki OCHIAI, Tokyo (JP)

(73) Assignee: CASIO COMPUTER CO., LTD., Tokyo (JP)

(21) Appl. No.: 19/064,334

(22) Filed: Feb. 26, 2025

(30) Foreign Application Priority Data
Feb. 29, 2024 (JP) 2024-029367

(51) Int. Cl. G04G 21/02; G04B 19/04; G04G 17/04; G04G 17/06

(52) U.S. Cl. CPC G04G 21/02; G04B 19/04; G04G 17/04; G04G 17/06

(57) ABSTRACT

An electronic timepiece includes: a hand; a wheel corresponding to the hand and having a hole; a detector corresponding to the wheel, the detector being configured to detect light that passes through the hole of the wheel in response to voltage being applied to the detector and configured to output current corresponding to an intensity of the detected light; and a processor. The processor obtains, at a predetermined timing, a current-based value that is based on the current output by the detector. The processor determines whether or not the current-based value is greater than or equal to a predetermined threshold. Based on the determination, the processor performs position detection of the hand. The predetermined timing is earlier than a timing at which the current-based value, which is based on the current output by the detector, becomes a value in a steady state.

### CROSS-REFERENCE TO RELATED APPLICATIONS

This application is based upon and claims the benefit of priority from the prior Japanese Patent Application No. 2024-029367, filed on Feb. 29, 2024, the entire contents of which are incorporated herein by reference.

### TECHNICAL FIELD

The present disclosure relates to an electronic timepiece, a hand position detection method, and a storage medium.

### DESCRIPTION OF RELATED ART

There is known a technique for detecting the position of a hand of an analog timepiece by detecting natural light or light emitted by a light-emitting element, such as an LED, with a light-receiving element, such as a phototransistor, as disclosed in Japanese Unexamined Patent Application No. 2006-284444. When a light-emitting element (e.g., an LED) is used to detect the position of a hand in the known art, the light-emitting element is illuminated after a voltage is applied to the light-receiving element; and the hand position detection is performed based on a threshold in the state where the current output by the light-receiving element is stable (in the stable period).

### SUMMARY OF THE INVENTION

According to an embodiment of the present disclosure, an electronic timepiece includes: a hand; a wheel corresponding to the hand and having a hole; a detector corresponding to the wheel, the detector being configured to detect light that passes through the hole of the wheel in response to voltage being applied to the detector and configured to output current corresponding to an intensity of the detected light; and a processor configured to obtain, at a predetermined timing, a current-based value that is based on the current output by the detector, determine whether or not the current-based value is greater than or equal to a predetermined threshold, and perform position detection of the hand, based on the determination, wherein the predetermined timing is earlier than a timing at which the current-based value, which is based on the current output by the detector, becomes a value in a steady state.

### BRIEF DESCRIPTION OF DRAWINGS

FIG. 1 is a schematic cross-sectional view of the main part of a timepiece related to the hand position detection in a first embodiment.

FIG. 2 is a block diagram illustrating the main control configuration of the timepiece in the embodiment.

FIG. 3A is a schematic cross-sectional view illustrating the positional relation between a light emitter and a detector in the first embodiment.

FIG. 3B is a schematic cross-sectional view illustrating the positional relation between the light emitter and the detector in the first embodiment, a FIG. 3C is schematic cross-sectional view illustrating the positional relation between the light emitter and the detector in the first embodiment.

FIG. 3D is a schematic cross-sectional view illustrating the positional relation between the light emitter and the detector in the first embodiment.

FIG. 4 is a timing chart of the hand position detection using a light emitter in the known art.

FIG. 5 is a timing chart of the hand position detection using the light emitter in this embodiment.

FIG. 6 is a schematic cross-sectional view of the main part of the timepiece in a second embodiment, illustrating the relation between the wheel train mechanism and the detector when the holes for the hand position detection are in a through-hole state.

FIG. 7 is a schematic cross-sectional view of the main part of the timepiece in the second embodiment, illustrating the relation between the wheel train mechanism and the detector when the holes for the hand position detection are not in a through-hole state.

FIG. 8 is a timing chart of the hand position detection using natural light in the embodiment.

FIG. 9 is a timing chart of the hand position detection using the light emitter in a modification example of the embodiment.

### DETAILED DESCRIPTION

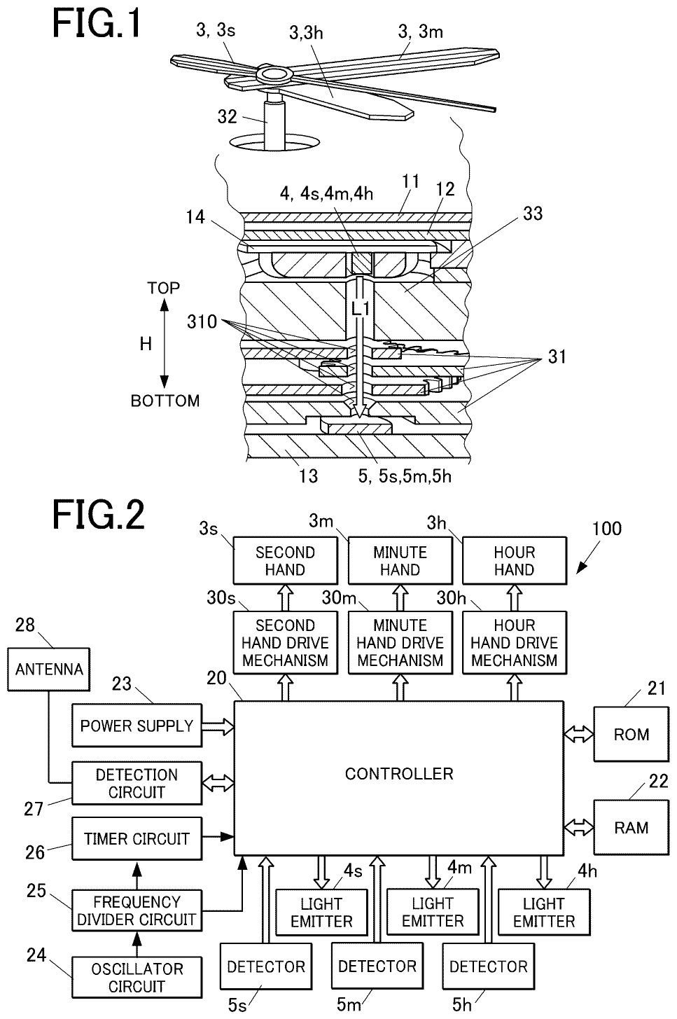

Hereinafter, an electronic timepiece, a hand position detection method, and a storage medium according to embodiments of the present disclosure are described with reference to FIG. 1 to FIG. 9. In the following description, an electronic timepiece is simply referred to as “timepiece”. The embodiments described below are provided with various limitations technically preferable for carrying out the present disclosure. However, the scope of the present disclosure is not limited to the embodiments below or illustrated examples.

### First Embodiment

A first embodiment of a timepiece 100, a hand position detection method, and a storage medium is described with reference to FIG. 1 to FIG. 5. As shown in FIG. 1 and FIG. 2, the timepiece 100 as an electronic timepiece of this embodiment includes hands 3, gear wheels 31 corresponding to the hands 3, a detector 5, and a controller 20. The timepiece 100 indicates time by an analog system. In this embodiment, the hands 3 include a second hand 3s, a minute hand 3m, and an hour hand 3ₕ. The timepiece 100 is not limited to a three-hand timepiece having three hands. The timepiece 100 may be a two-hand timepiece having only the minute hand 3m and the hour hand 3h, for example.

The hands 3 are attached to hand shafts 32 having a common axial center. The hands 3 are rotated on the hand shafts 32 by their corresponding drive mechanisms 30 (a second hand drive mechanism 30s, a minute hand drive mechanism 30m, and an hour hand drive mechanism 30h in FIG. 2) to indicate appropriate time. The drive mechanisms 30 each include a wheel train mechanism constituted of wheels 31 and a not-illustrated motor that drives the wheel train mechanism. There may be motors for the respective hands 3, or there may be one motor for the hands 3. In the sectional side view of the internal main configuration of the timepiece 100 as illustrated in FIG. 1, the timepiece 100 includes a dial 11, a solar panel 12, a date indicator holder 33, wheels 31 constituting the wheel train mechanism, and a board (main board 13) from the top in the thickness direction H (the top-bottom direction, the axial direction of the hand shaft 32 in FIG. 1).

The wheels 31 are arranged in the thickness direction H. At least part of the wheels 31 have through holes 310 that pass through the wheel in the thickness direction H. The wheels 31 are rotated by the drive mechanism 30. The holes 310 formed in the multiple wheels 31 overlap each other at a specific time(s) by the rotation of the wheels 31. At the specific time, the holes 310 form a through hole in the thickness direction H of the timepiece 100 (the holes 310 are in a through-hole state) and allow light (light L1 in FIG. 1 and other figures) to pass through the holes 310 in the through-hole state. In this embodiment, the light L1 that passes through the holes 310 in the through-hole state is the emitted light L1 emitted by a light emitter 4, which is described later.

As shown in FIG. 1, above and below the position at which the holes 310 formed in the wheels 31 overlap, a light emitter(s) 4 and a detector(s) 5 are disposed so as to face each other. As shown in FIG. 2, the light emitters 4 include a light emitter 4s for the second hand, a light emitter 4m for the minute hand, and a light emitter 4h for the hour hand; and the detectors 5 include a detector 5s for the second hand, a detector 5m for the minute hand, and a detector for the hour hand. In this embodiment, the hand position is detected at the position at which the light emitter 4 faces the detector 5 via the holes 310 in the through-hole state. The configuration of the light emitter 4 and the detector 5 is common for all the hands 3 (the second hand 3s, the minute hand 3m, and the hour hand 3h). Therefore, in the following, the “light emitter 4” may include the light emitter 4s for the second hand, the light emitter 4m for the minute hand, and the light emitter 4h for the hour hand; and the “detector 5” may include the detector 5s for the second hand, the detector 5m for the minute hand, and the detector 5h for the hour hand.

The light emitter 4 is a light-emitting element, such as a light-emitting diode (LED), for example. The light emitter 4 is turned on and emits light when a predetermined voltage (input voltage) is applied to the light emitter 4. In the example of FIG. 1, the light emitter 4 is mounted on a subsidiary board 14 disposed at the back surface side (the lower side in the thickness direction H) of the dial 11 and the solar panel 12 such that the light emitting side of the light emitter 4 faces the detector 5. The detector 5 is constituted of a light-receiving element, such as a phototransistor (“PTr” in FIG. 5), for example. The detector 5 is disposed below the corresponding wheel train mechanism, which consists of the wheels 31 and moves the corresponding hand 3. Specifically, the detector 5 is disposed on the main board 13 so as to face the light emitter 4.

Further, in this embodiment, the detector 5 has a primary light-receiving surface 51 having a high light-receiving sensitivity and a secondary light-receiving surface 52 having a lower light-receiving sensitivity than that of the primary light-receiving surface 51 on the top and the bottom of the detector 5 in the thickness direction H. A not-illustrated electrode is provided at the side of the primary light-receiving surface 51. That is, the primary light-receiving surface 51 is a first surface having a high light-receiving sensitivity and an electrode part; and the secondary light-receiving surface 52 is a second surface opposite the primary light-receiving surface 51 (the first surface) and having a lower light-receiving sensitivity than that of the primary light-receiving surface 51. In this embodiment, the detector 5 is mounted on the board (e.g., the main board 13) such that the first surface at the electrode side (the primary light-receiving surface 51) faces the board (the main board 13). On the board (main board 13), an electrode part 131 is formed. In the mounted state, the electrode of the detector 5 is electrically connected to the electrode part 131 of the board (main board 13). That is, the detector 5 is directly mounted on the board (main board 13) by the surface mount technology (SMT), and there is no need to protect the electrode side of the detector 5 with resin or to do wire-bonding of wires from the electrode. Accordingly, the detector 5 can be made thin and mounted in a narrower area. Further, eliminating the need of wire bonding contributes cost reduction. In such a configuration, the secondary light-receiving surface 52 of the detector 5 faces the light emitter 4.

The detector 5 detects the light L1 when a voltage (input voltage) is applied to the detector 5 and outputs a current corresponding to the intensity of the detected light L1. The intensity of light detected by the detector 5 when the detector 5 simply receives the light L1 emitted by the light emitter 4 is called the intensity of light in the “steady state”. In the following embodiments, the current value (voltage value) in the steady state is described as if it is a constant value. In actual cases, however, the current value (voltage value) fluctuates to a certain extent, and the steady state includes a state having such fluctuations.

In this embodiment, a voltage is applied to the detector 5 after the timing at which the light L1 emitted by the light emitter 4 passes through the holes 310 of the wheels 31. When the holes 310 of the wheels 31 overlap and are in the through-hole state, the emitted light L1 reaches the detector 5, which faces the light emitter 4. The detector 5 does not output a current until an input voltage (an input pulse for detection in FIG. 5 and other figures) is applied to the detector 5 but stores electric charge in the parasitic capacity. When a voltage is applied to the detector 5 in the state where electric charge is stored in the parasitic capacity, the detector 5 as a phototransistor PTr outputs, by the transient response, a current having a greatly amplified higher value than the current value at the time of detecting the intensity of light in the steady state (the current value in the steady state, the value at the level of “a” in FIG. 5 and other figures). In this embodiment, the detector 5 outputs the current value to the controller 20. In this embodiment, the controller 20 performs the AD conversion (shown as “AD” in FIG. 5 and other figures) of converting the current value output by the detector 5 to a voltage value. The comparator (shown as “COMP” in FIG. 5 and other figures) compares the voltage value with a predetermined threshold, and the controller 20 determines whether the voltage value exceeds the threshold.

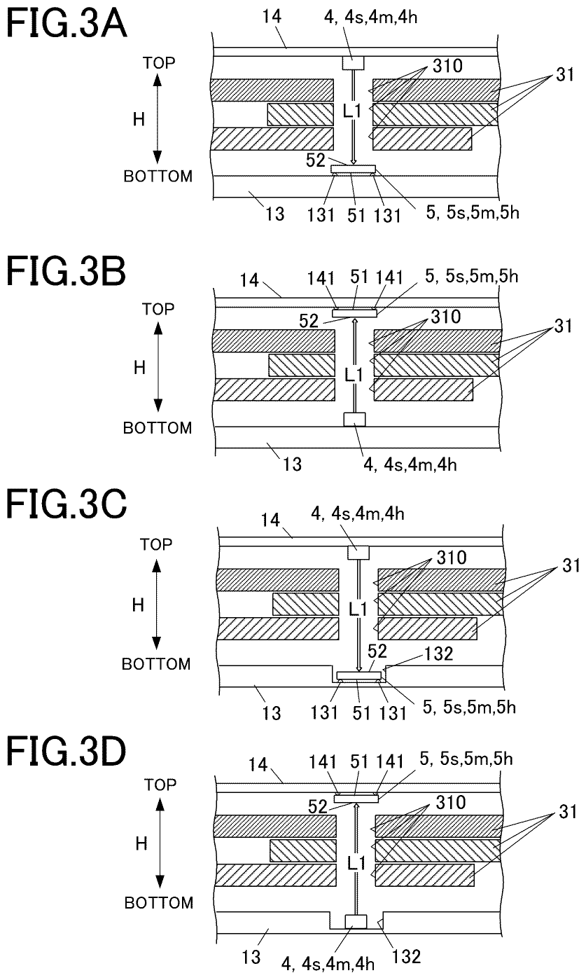

The light emitter 4 and the detector 5 are arranged to face each other. The arrangement pattern is not specifically limited as long as the detector 5 can receive the light L1 emitted by the light emitter 4 when the holes 310 are in the through-hole state. For example, in FIG. 1 and FIG. 3A, the light emitter 4 is disposed on the subsidiary board 14 above the wheel train mechanism; and the detector 5 is disposed on the main board 13 at a lower part in the thickness direction H such that the detector 5 faces the light emitter 4. For another example, in FIG. 3B, the detector 5 is disposed on the subsidiary board 14 above the wheel train mechanism; and the light emitter 4 is disposed on the main board 13 at a lower part in the thickness direction H such that the light emitter 4 faces the detector 5.

Further, the surface of the main board 13 may be recessed so that components disposed on the board are below the reference surface of the board. For example, in FIG. 3C, the detector 5 is disposed in the recess 132 formed in the main board 13. For another example, in FIG. 3D, the light emitter 4 is disposed in the recess 132 formed in the main board 13. With the recess 132, the space for mounting the light emitter 4 and the detector 5 can be reduced. When the detector 5 is mounted on the subsidiary board 14 as illustrated in FIG. 3B and FIG. 3D, the electrode on the primary light-receiving surface 51 of the detector 5 is electrically connected to the electrode 141 formed on the subsidiary board 14; and the light emitter 4 faces the secondary light-receiving surface 52 of the detector 5. FIG. 1 and FIG. 3A to FIG. 3D schematically illustrate examples of the configuration to the extent necessary for explanation and do not illustrate the internal configuration of the actual timepiece 100, such as the number and the arrangement of wheels 31 constituting the wheel train mechanism.

As shown in FIG. 2, the timepiece 100 includes: the controller 20 constituted of a central processing unit (CPU) and so forth; a read only memory (ROM) 21; and a random access memory (RAM) 22. The controller 20 performs various arithmetic processes of the analog timepiece 100 and centrally controls overall operations of the timepiece 100. In this embodiment, the controller 20 serves as a processor that controls the hand position detection operation. That is, the controller 20 receives the current value from the detector 5, converts the current value into a voltage value, and obtains the voltage value at a predetermined timing as a current-based value. Herein, the predetermined timing is a timing before the current-based value (the voltage value in this embodiment) reaches the value in the steady state at the “a” level in FIG. 5 and other figures. Furthermore, in practice, the predetermined timing is a timing after a predetermined time elapses from the application of a voltage (a detection pulse) to the detector 5. The predetermined time is, for example, about three milliseconds. Although the predetermined time is not limited to three milliseconds, it is preferable that the predetermined time be fixed to avoid variations in detection results.

The controller 20 determines, by the comparator operation, whether the current-based value (in this embodiment, the voltage value after the AD conversion (AD-converted value)) is greater than or equal to a predetermined threshold. Based on the determination result, the controller 20 performs the hand position detection. The threshold of the hand position detection is determined by the total of (i) the voltage value (AD-converted value) into which the detection result (output current value) by the detector 5 is converted in the state where the light emitter 4 is turned off and (ii) the output specific to the wheel train mechanism, for example. The determined threshold is stored in the storage, such as the ROM 21 or the RAM 22, as the threshold of the hand position detection for the corresponding hand 3, for example.

The controller 20 also controls ON/OFF of the light emitter 4 and the detector 5 by applying an input voltage to the light emitter 4 to turn on the light emitter 4, by applying an input voltage to the detector 5 (e.g., detection pulse) to turn on the detector 5, and so forth. As described, in the hand position detection in this embodiment, the light emitter 4 (e.g., an LED) is turned on before a voltage is applied to the detector 5. That is, a voltage is applied to the detector 5 after a predetermined time elapses from the turning on of the light emitter 4. The predetermined time is appropriately determined. Since the predetermined time is for storing electric charge in the parasitic capacity as described above, it is preferable that electric charge be sufficiently stored in the parasitic capacity during the predetermined time. The predetermined period is, for example, about 50 milliseconds.

The ROM 21 is a nonvolatile memory that stores the control program and operation programs related to various functions of the timepiece 100 executed by the controller 20, such as the function of the hand position detection process. The ROM 21 stores various data necessary for the hand position detection operation and other operations. The RAM 22 is a volatile memory that provides a working memory space for the controller 20 and stores loaded programs, temporary data, and so forth. The RAM 22 also stores information, such as hand position information of the hands 3 (i.e., the second hand 3s, the minute hand 3m, and the hour hand 3h).

As shown in FIG. 2, the timepiece 100 also includes a power supply 23 that supplies power to the components of the timepiece 100 via the controller 20; various circuits necessary for the timepiece 100 to indicate time (e.g., an oscillator circuit 24, a frequency divider circuit 25, a timer circuit 26, a detection circuit 27); and an antenna 28. The components of the timepiece 100 are not limited to those examples. The controller 20, the ROM 21, the RAM 22, the oscillator circuit 24, the frequency divider circuit 25, the timer circuit 26, the detection circuit 27, and so forth may be mounted on a circuit board of the board (the main board 13) to form a large scale integration (LSI). Since the configurations of the components, such as the oscillator circuit 24, the frequency divider circuit 25, the timer circuit 26, and the detection circuit 27, are well known in the art, they are not described here.

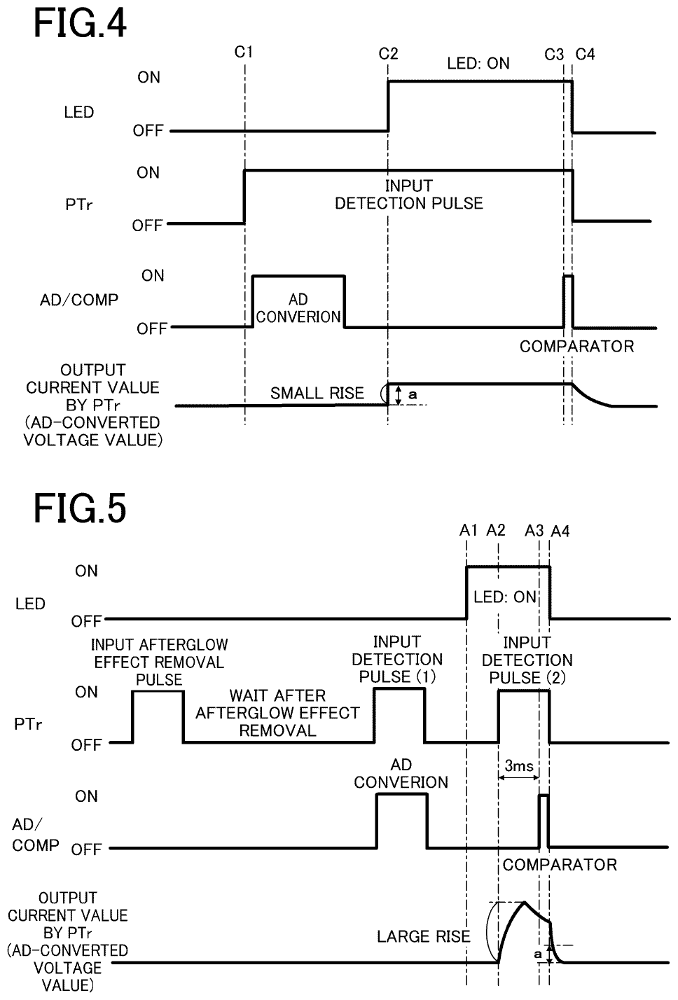

Next, the operation of the timepiece 100 according to this embodiment, particularly the hand position detection method, will be described in detail with reference to FIG. 5 and other figures. Before the description of the hand position detection method according to the embodiment, the hand position detection method in the known art will be described with reference to FIG. 4 for comparison. It is preferable that the hand position detection in both the known art and this embodiment be performed in the state where dumping actions of the motors of the drive mechanisms that move the hands 3 are settled after the hands 3 are moved. In both the known art and this embodiment, the threshold of the hand position detection is determined by the total of (i) the voltage value (AD-converted value) converted from the detection result (output current value) by the detector 5 in the state where the light emitter 4 is turned off and (ii) the output specific to the wheel train mechanism, for example. FIG. 4 and FIG. 5 illustrate the time axis from the left to the right.

In the hand position detection of the known art, firstly at the timing C1, an input voltage (a detection pulse) is applied to the detector as a phototransistor (PTr in FIG. 4) to turn on the detector, as shown in FIG. 4. After the application of the input voltage, at the timing C2, an input voltage is applied to the light emitter (e.g., an LED) to turn on the light emitter. The timing C2 is the timing after a sufficient time elapses for the phototransistor PTr (detector) to output stable outputs. The sufficient time for the phototransistor PTr to output stable outputs is, for example, about 20 milliseconds. The phototransistor PTr outputs a current value corresponding to the intensity of the detected light L1. The output current value is converted to a voltage value. The comparator compares the voltage value with a threshold (C3 to C4). Based on the comparison result, the controller determines that the holes are in the through-hole state when the voltage value exceeds the threshold; whereas the controller determines that the holes are not in the through-hole state when the voltage value does not exceed the threshold.

According to the known method, the current-based value (e.g., the AD-converted voltage value) based on the current output by the phototransistor PTr at the timing C2 at which the light emitter (e.g., an LED) is turned on is the “a” level value corresponding to the light L1 emitted by the light emitter. This “a” level value is the current-based value (voltage value) in the steady state. As shown in FIG. 4, the increase of the current-based value to the “a” level value in the steady state is small. Depending on the output by the light emitter, it may be wrongly determined that the value does not exceed the threshold even though the holes are actually in the through-hole state.

On the other hand, in the method of this embodiment, as shown in FIG. 5, firstly an input voltage (detection pulse (1)) is applied to the phototransistor PTr as the detector 5 to turn on the phototransistor PTr in the state where the light emitter 4 (e.g., an LED) is turned off. The controller 20 performs the AD conversion of the current value output by the detector 5 to obtain a voltage value (AD-converted value). The controller 20 adds up the AD-converted value and the output specific to the wheel train mechanism to determine a total value, and stores the total value as the threshold in the storage, such as the RAM 22. Next, in the actual hand position detection, an input voltage is applied to the light emitter 4 (e.g., an LED) to turn on the light emitter 4 at the timing A1. After a predetermined time (e.g., about 50 milliseconds) elapses from the turning on of the light emitter 4 (e.g., an LED), an input voltage (detection pulse (2)) is applied to the phototransistor (PTr in FIG. 5) as the detector 5 to turn on the phototransistor at the timing A2 in FIG. 5. The phototransistor PTr as the detector 5 outputs a current value corresponding to the intensity of the detected light L1, and the output current value is subjected to the AD conversion.

At the timing A3 (the predetermined timing), the controller 20 obtains the AD-converted value (voltage value) as the current-based value based on the current output by the detector 5. The predetermined timing is the timing before the current-based value becomes the value in the steady state. Further, the predetermined timing is the timing after the predetermined time elapses since the application of voltage to the detector 5. In this embodiment, the predetermined time after the application of voltage to the detector 5 is about three milliseconds as shown in FIG. 5, for example. The controller 20 obtains the current-based value (voltage value) and compares the current-based value (voltage value) with the threshold using the comparator (A3 to A4). Based on the comparison result, the controller 20 determines that the holes 310 are in the through-hole state when the current-based value (voltage value) exceeds the threshold; whereas the controller 20 determines that the holes 310 are not in the through-hole state when the current-based value does not exceed the threshold. In the example shown in FIG. 5, at the timing A4 at which the comparator ends comparison, the LED as the light emitter 4 is turned off; and the application of voltage to the detector 5 (input of the detection pulse) is also stopped to turn off the detector 5. Although the timing of turning off the light emitter 4 and the detector 5 is not limited to the timing A4, unnecessary power consumption can be reduced by turning off the light emitter 4 and the detector 5 at the timing A4 at which the comparator ends comparison.

In this embodiment, electric charge is stored in the parasitic capacity during the period between the lighting up of the light emitter 4 (e.g., an LED) and the application of an input voltage to the detector 5 (the phototransistor PTr). As shown in FIG. 5, when an input voltage is applied to the detector 5 (the phototransistor PTr), the detector 5 outputs, by the transient response, a current having a greatly amplified value than the current value that is normally output by the detector 5 when the light emitter 4 is turned on (i.e., the “a” level current value in the steady state). In this embodiment, the controller 20 obtains the current-based value based on the current output by the detector 5 (the AD-converted voltage value) and compares the current-based value with the threshold at the timing after the predetermined time (about three milliseconds) elapses from the application of voltage to the detector 5, specifically at the timing after the current value output by the phototransistor PTr (the voltage value after the AD conversion) reaches its peak, as shown in FIG. 5.

As shown in FIG. 5, the current-based value becomes the “a” level value in the steady state after the timing A4 at which the comparator ends comparison; and during the period between A3 and A4 during which the comparator is doing comparison, the voltage value as the current-based value greatly exceeds the “a” level value in the steady state. Therefore, the controller 20 obtains the current-based value (the AD-converted voltage value) based on the current output by the detector 5 at the timing before the current-based value reaches the “a” level value in the steady state in FIG. 5. Therefore, even if the output by the light emitter 4 is relatively small, or even if the secondary light-receiving surface 52 having a relatively low light receiving sensitivity receives the light L1 emitted by the light emitter 4 as in this embodiment, the current-based value greatly exceeds the threshold with high accuracy as long as the holes 310 are in the through-hole state. Thus, it is less likely to wrongly determine whether the holes 310 are in the through-hole state, and the hand position detection can be performed with high accuracy. In FIG. 5, an afterglow effect removal pulse (i.e., an input voltage) is input to the phototransistor PTr as the detector 5 for about 30 milliseconds before the start of the hand position detection; and then the detection operation is started after a while (e.g., 50 milliseconds). However, the input of the afterglow effect removal pulse and the waiting time after the afterglow effect removal (WAIT after afterglow effect removal in FIG. 5) may be omitted.

As described above, according to this embodiment, the timepiece 100 includes: the hands 3; the wheels 31 corresponding to the respective hands 3 and having the holes 310; the detector(s) 5 corresponding to the respective wheels 31; and the controller 20. A voltage is applied to the detector 5 after the light L1 passes through the holes 310 of the wheels 31 and, in response to the voltage being applied to the detector 5, the detector 5 detects the light L1 passing through the holes 310 and outputs a current corresponding to the intensity of the detected light L1. According to the above configuration, electric charge is stored in the parasitic capacity, and the detector 5 detects the current having a greatly amplified value by the transient response than the normal value in the steady state. The controller 20 obtains a current-based value that is based on the current output by the detector 5 at a predetermined timing and determines whether the current-based value is greater than or equal to a predetermined threshold. Based on the determination result, the controller 20 performs the hand position detection. The predetermined timing is the timing before the current-based value reaches the value in the steady state. Thus, the controller 20 can obtain a high current-based value to compare with the threshold. Thus, the controller 20 can avoid wrongly determining that the holes 310 are not in the through-hole state even though the holes 310 are actually in the through-hole state, based on the current-based value output by the detector 5 not exceeding the threshold. Thus, the controller 20 can appropriately perform the hand position detection with high accuracy.

When a light-emitting element (e.g., an LED) is used in the hand position detection of the known art, the light-emitting element is turned on after a voltage is applied to a light-receiving element; and the hand position detection is performed based on the threshold in the state where the current output by the light-receiving element is stable (stable period), for example. However, according to such a known method, the light-emitting element requires a large amount of electric power so that the light-receiving element stably outputs currents that greatly exceed the threshold. As a result, a large amount of power is consumed.

According to the method this of embodiment, immediately after a voltage is applied to the detector 5, the detector 5 detects a current having a greatly amplified value than the value in the steady state. As compared with the known method, the method of this embodiment can shorten the time during which the LED as the light emitter 4 is turned on and the time during which a voltage is applied to the phototransistor PTr as the detector 5. Thus, the power consumption for the hand position detection can be reduced.

Further, the predetermined timing is earlier than the timing at which the current-based value becomes the “a” level value in the steady state, and the predetermined timing is a predetermined time after a voltage is applied to the detector 5. Therefore, the controller 20 can compare the current-based value output by the detector 5 with the threshold while the current-based value is greatly amplified and higher than the normal value in the steady state by the transient response with the electric charge stored in the parasitic capacity. The period during which the current-based value is greater than the value in the steady state is not so long. By meeting time conditions to obtain a value to be compared with the threshold, it is possible to obtain comparison results with consistent conditions.

The timepiece 100 in this embodiment further includes the light emitter 4 that is disposed to face the detector 5 and configured to emit the light L1 toward the detector 5. In the hand position detection, the light emitter 4 is turned on before a voltage is applied to the detector 5. According to the above configuration, electric charge is stored in the parasitic capacity before a voltage is applied to the detector 5, so that the detector 5 outputs a greatly amplified and higher value by the transient response than the normal value in the steady state. In this embodiment, the controller 20 applies a voltage to the detector 5 a predetermined time after turning on the light emitter 4. Accordingly, enough electric charge is stored in the parasitic capacity, and the obtained current-based value is easy to compare with the threshold to determine whether the obtained current-based value exceeds the threshold.

Further, the detector 5 in this embodiment has the primary light-receiving surface 51 having a high light-receiving sensitivity and the secondary light-receiving surface 52 having a light-receiving sensitivity lower than the light-receiving sensitivity of the primary light-receiving surface 51. When the detector 5 has an electrode on the side of the primary light-receiving surface 51, the detector 5 is mounted on the board (e.g., the main board 13) such that the primary light-receiving surface 51 having the electrode faces the board (e.g., the main board 13). If a printed circuit board having a circuit pattern is used as the board (e.g., main board 13), it is possible to directly mount the detector 5 (e.g., the phototransistor PTr) on the surface of the board (e.g., main board 13) using the SMT and to join the electrode of the detector 5 to the electrode 131 of the board (e.g., main board 13). Such a configuration eliminates the need of wire bonding, and the detector 5 can be easily mounted in a smaller area. Further, the work and cost of wire bonding can be reduced.

When the detector 5 is mounted on the board such that the primary light-receiving surface 51 faces the board, the detector 5 has a decreased detection sensitivity. Since electric charge is stored in the parasitic capacity and the detector 5 detects a current having a greatly amplified value by the transient response than the normal value in the steady state, it is possible to sufficiently cover the decrease in detection sensitivity.

Further, in this embodiment, the current-based value obtained before the current-based value becomes the value in the steady state (the “a” level value) is a temporarily amplified value by the electric charge stored in the parasitic capacity by the light L1 reaching the detector 5. Therefore, even when the light output by the light emitter 4 has a low intensity or when the detector 5 has a low detection sensitivity, the current-based value output by the detector 5 exceeds the threshold. Accordingly, it is possible to avoid wrong determination that the holes are not in the through-hole state even though the holes are actually in the through-hole state.

Further, in this embodiment, an afterglow effect removal pulse that resets the parasitic capacity is input to the detector 5 before a voltage (a detection pulse) is input to the detector 5. This can remove the effect of electric charge in the parasitic capacity stored before the light L1 from the light emitter 4 reaches the detector 5.

### Second Embodiment

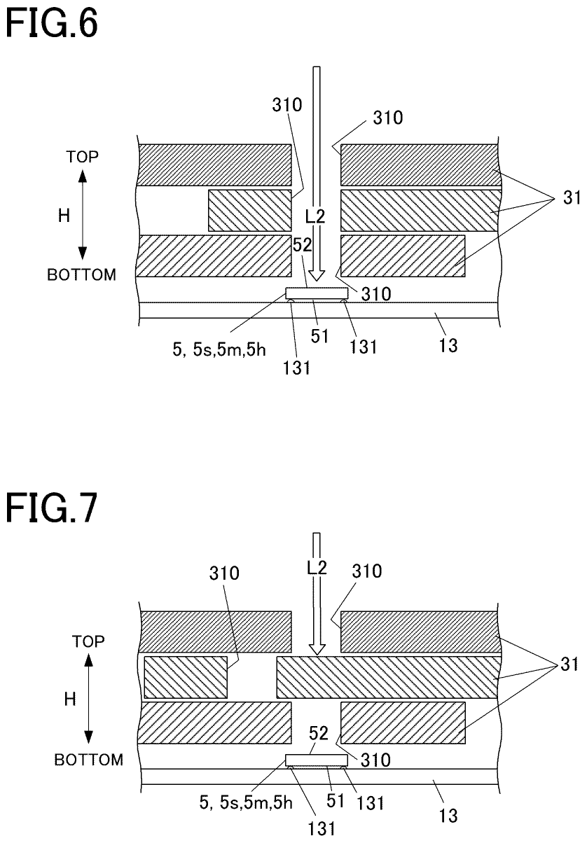

A second embodiment of the timepiece 100, the hand position detection method, and the storage medium is described with reference to FIG. 6 to FIG. 8. In this embodiment, the timepiece as an electronic timepiece does not include a light emitter (e.g., an LED), and the detector 5 detects natural light (light from outside, the light L2 in FIG. 6 and FIG. 7). The other parts of the timepiece in the second embodiment are the same as in the first embodiment. The following is the description on the aspects different from the first embodiment. The components of the second embodiment that are the same as that of the first embodiment are denoted by the same symbols, and the description thereof is omitted.

As shown in FIG. 6 and FIG. 7, the timepiece in this embodiment includes wheels 31 arranged in the thickness direction H; and at least part of the wheels 31 have through holes 310 that pass through the wheel in the thickness direction H, as in the first embodiment. The wheels 31 are rotated by the drive mechanism 30. The holes 310 formed in the multiple wheels 31 overlap each other at a specific time(s) by the rotation of the wheels 31. As shown in FIG. 6, below the position at which the holes 310 formed in the wheels 31 overlap, the detector 5 is disposed (the detector 5s for the second hand, the detector 5m for the minute hand, and the detector for the hour hand in FIG. 2). The configuration in the second embodiment is the same as in the first embodiment except that a light emitter is not provided opposite the detector 5. The detector 5 is directly mounted on the board (e.g., the main board 13) by the SMT.

In FIG. 6, the holes 310 are in the through-hole state in the thickness direction H of the timepiece 100, and the light L2 passes through the holes 310 in the through-hole state. In this embodiment, the natural light L2 passes through the holes 310 in the through-hole state, as described above. The holes 310 in the through-hole state serve as an opening to introduce natural light (the opening in the open state). When the positions of the holes 310 formed in the wheels 31 do not match as shown in FIG. 7, namely when the opening for introducing natural light is closed, the light L2 from the above is blocked by the wheel(s) 31 and does not reach the detector 5 disposed on the board (e.g., the main board 13) below the wheels 31. Since the other configuration is the same as in the first embodiment, the description thereof is omitted.

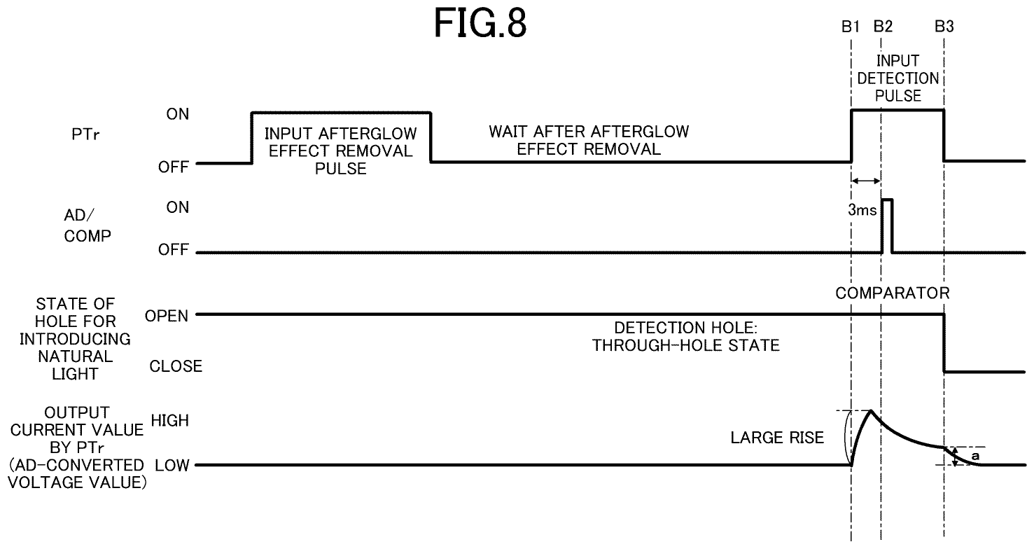

In this embodiment, the natural light L2 is used to perform the hand position detection, and the wheels 31 constituting the wheel train mechanism are arranged at specific positions. When the holes 310 of the wheels 31 for detection overlap and are in the through-hole state (the opening for introducing natural light is open, as exemplified in FIG. 6), the natural light L2 enters the timepiece from the outside. Before starting the hand position detection, the controller 20 inputs an afterglow effect removal pulse (i.e., applies an input voltage) to the detector 5 (the phototransistor PTr). The afterglow effect removal pulse is input for about 30 milliseconds, for example. After removing the afterglow effect, the controller 20 waits for about 50 milliseconds (WAIT after afterglow effect removal in FIG. 8). At the timing B1, the controller 20 again applies an input voltage (a detection pulse) to the detector 5 for about 10 milliseconds.

As shown in FIG. 8, since the holes 310 for detection are in the through-hole state before the afterglow effect removal pulse is input, the natural light L2 enters through the through-hole state holes 310. By the entering natural light L2, electric charge is stored in the parasitic capacity of the detector 5 (phototransistor PTr). When a voltage (a detection pulse) is applied to the detector 5, the detector 5 (phototransistor PTr) detects a current having a greatly amplified value by the transient response than the normal value in the steady state. Accordingly, the detector 5 outputs a high current value, as shown in FIG. 8. The output current value is converted to a voltage value by the AD conversion, and the converted voltage value is obtained by the controller 20 as the current-based value at the predetermined timing (B2 in FIG. 8) after an input voltage (a detection pulse) is applied to the detector 5. The current-based value is then compared with the threshold by the comparator. Herein, the predetermined timing is the timing about three milliseconds after an input voltage (a detection pulse) is applied to the phototransistor PTr as the detector 5, as in the first embodiment. When the voltage value (the current-based value) is greater than the threshold, the controller 20 determines that the holes 310 are in the through-hole state. When the voltage value is less than the threshold, the controller 20 determines that the holes 310 are not in the through-hole state.

It is assumed that the intensity of the natural light L2 is less than the intensity of the light L1 emitted by the light emitter (e.g., an LED). In this embodiment, the transient response by the parasitic capacity is utilized to obtain a current-based value that is greatly amplified than the value in the steady state (the “a” level value in FIG. 8).

In this embodiment, the following advantageous effects can be obtained in addition to the effects of the first embodiment. In this embodiment, the detector 5 detects the natural light L2 passing through the holes 310 of the wheels 31. Since the timepiece does not require a light emitter (e.g., an LED), a space can be saved. Further, since the timepiece does not require electric power for turning on the light emitter, the power consumption can be reduced. When the hand position detection is performed with the natural light L2 without a light emitter (e.g., an LED), the intensity of light may be insufficient depending on the environment, and the current output by the light receiver may not exceed the threshold. In this regard, although this embodiment uses the natural light L2 having a relatively weak light intensity to perform the hand position detection, the current-based value (a current value or a voltage value) obtained for comparison with the threshold is greatly amplified by the transient response than the value in the steady state. Therefore, it is possible to determine whether the holes 310 are in the through-hole state with high accuracy and to avoid wrong determination in the hand position detection.

In this embodiment utilizing the natural light L2, when the electrode of the detector 5 is provided on the primary light-receiving surface 51, the detector 5 may be mounted on the board by the SMT such that the primary light-receiving surface 51 faces the board (the main board 13) and is electrically connected to the electrode 131 on the board. As described above, the obtained current-based value (a current value or a voltage value) is a greatly amplified value by the transient response than the value in the steady state. Therefore, the obtained current-based value can be compared with the threshold without a problem even when light is received by the secondary light-receiving surface 52 having a relatively low light-receiving sensitivity.

Although the embodiment of the present invention has been described, the embodiment is not intended to limit the present invention and can be variously modified without departing from the scope of the invention.

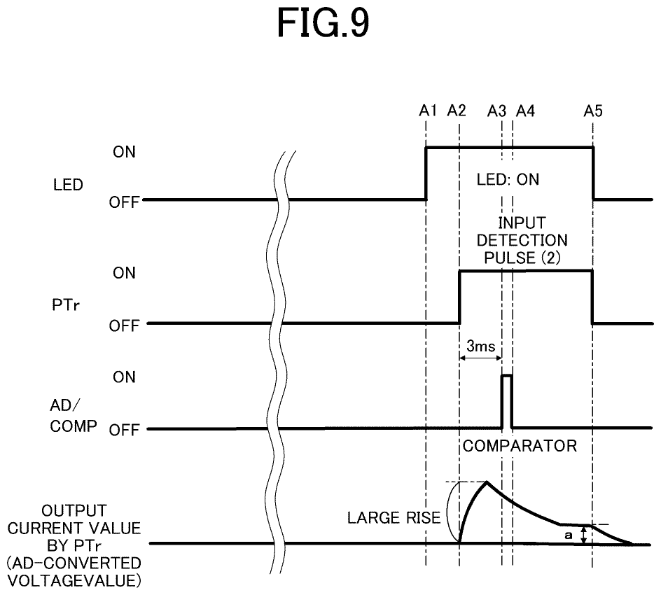

For example, in the first embodiment, the input of voltage to the light emitter 4 (an LED) and the input of the detection pulse (2) to the detector 5 is stopped before the current value (voltage value) output by the detector 5 (phototransistor PTr) reaches the “a” level value in the steady state, as shown in FIG. 5. However, the timing of stopping the input of voltage to the light emitter 4 and the input of the detection pulse (2) to the detector 5 is not limited to the timing shown in FIG. 5, as long as the controller obtains the voltage value (current value) and performs the comparator operation before the current-based value reaches the “a” level value in the steady state. For example, in FIG. 9, the controller obtains the current value (voltage value) and performs comparator operation before the current-based value reaches the “a” level value in the steady state. As shown in FIG. 9, the application of voltage to the LED (the light emitter 4) and the input of the detection pulse (2) to the detector 5 may be stopped at the timing (A5 in FIG. 9) after the current value (voltage value) output by the phototransistor PTr reaches the “a” level value in the steady state. Furthermore, the timing of stopping the input of voltage to the LED (light emitter 4) may not be the same as the timing of stopping the input of the detection pulse (2) to the detector 5. These timings may be different. In FIG. 9, the process before the timing A1 at which the LED (the light emitter 4) is turned on is omitted.

Furthermore, in FIG. 8 illustrating the timing chart of the second embodiment, the input of voltage (detection pulse) to the detector 5 is stopped when the output current value (voltage value) from the phototransistor PTr reaches the “a” level value in the steady state. However, the timing of stopping the input of voltage (detection pulse) to the detector 5 is not limited to the illustrated example. The timing of stopping the input of voltage (detection pulse) to the detector 5 may be before the timing B3 in FIG. 8, as long as the input of voltage is stopped after the comparator ends operation. For example, the input of voltage (detection pulse) to the detector 5 may be stopped immediately after the comparator ends operation. Stopping the input of voltage at an early stage can reduce unnecessary power consumption.

In the above embodiments, the current-based value to be compared with the threshold is a voltage value converted by the AD conversion from a current value output by the phototransistor PTr (the detector 5), as an example. However, the current-based value and the threshold are not limited to voltage values. For example, the current value output by the detector 5 may be used as the current-based value without being converted to a voltage value.

Although one or more embodiments of the present invention have been described, the scope of the present invention is not limited to the above-described embodiment but includes the scope of claims and the scope of their equivalents.

What is claimed is:

1. An electronic timepiece comprising:
a hand;
a wheel corresponding to the hand and having a hole;
a detector corresponding to the wheel, the detector being configured to detect light that passes through the hole of the wheel in response to voltage being applied to the detector and configured to output current corresponding to an intensity of the detected light; and
a processor configured to obtain, at a predetermined timing, a current-based value that is based on the current output by the detector, determine whether or not the current-based value is greater than or equal to a predetermined threshold, and perform position detection of the hand, based on the determination, wherein
the predetermined timing is earlier than a timing at which the current-based value, which is based on the current output by the detector, becomes a value in a steady state.

2. The electronic timepiece according to claim 1, wherein
the current-based value obtained at the predetermined timing is a value temporarily amplified by an electric charge stored in a parasitic capacity by light hitting the detector.

3. The electronic timepiece according to claim 2, wherein an afterglow effect removal pulse that resets the parasitic capacity is input to the detector before the voltage is applied to the detector.

4. The electronic timepiece according to claim 1, wherein:
the predetermined timing is earlier than the timing at which the current-based value becomes the value in the steady state, and
the predetermined timing is a predetermined time after the voltage is applied to the detector.

5. The electronic timepiece according to claim 1, further comprising a light emitter that is disposed to face the detector and configured to emit light toward the detector, wherein
in the position detection of the hand, the processor turns on the light emitter before applying the voltage to the detector.

6. The electronic timepiece according to claim 5, wherein the processor applies the voltage to the detector a predetermined time after turning on the light emitter.

7. The electronic timepiece according to claim 1, wherein the light that passes through the hole and that is detected by the detector is natural light.

8. The electronic timepiece according to claim 1, wherein:
the detector has a first surface and a second surface, the first surface having a high light-receiving sensitivity and having an electrode, the second surface being opposite the first surface and having a light-receiving sensitivity lower than the light-receiving sensitivity of the first surface, and
the detector is mounted on a board such that the first surface faces the board.

9. A hand position detection method to be executed by a processor of an electronic timepiece that includes a hand; a wheel corresponding to the hand and having a hole; and a detector corresponding to the wheel, the detector being configured to detect light that passes through the hole of the wheel in response to voltage being applied to the detector and configured to output current corresponding to an intensity of the detected light, the method comprising:
obtaining, at a predetermined timing, a current-based value that is based on the current output by the detector,
determining whether or not the current-based value is greater than or equal to a predetermined threshold, and
performing position detection of the hand, based on the determination,
wherein the predetermined timing is earlier than a timing at which the current-based value, which is based on the current output by the detector, becomes a value in a steady state.

10. The hand position detection method according to claim 9, wherein
the current-based value obtained at the predetermined timing is a value temporarily amplified by an electric charge stored in a parasitic capacity by light hitting the detector.

11. The hand position detection method according to claim 10, wherein an afterglow effect removal pulse that resets the parasitic capacity is input to the detector before the voltage is applied to the detector.

12. The hand position detection method according to claim 9, wherein:
the predetermined timing is earlier than the timing at which the current-based value becomes the value in the steady state, and
the predetermined timing is a predetermined time after the voltage is applied to the detector.

13. The hand position detection method according to claim 9, wherein:
the electronic timepiece further includes a light emitter that is disposed to face the detector and configured to emit light toward the detector, and
in the position detection of the hand, the light emitter is turned on before the voltage is applied to the detector.

14. The hand position detection method according to claim 13, wherein the voltage is applied to the detector a predetermined time after the light emitter is turned on.

15. A non-transitory computer-readable storage medium storing a program that is executable by a computer of an electronic timepiece that includes a hand; a wheel corresponding to the hand and having a hole; and a detector corresponding to the wheel, the detector being configured to detect light that passes through the hole of the wheel in response to voltage being applied to the detector and configured to output current corresponding to an intensity of the detected light, the program causing the computer to:
obtain, at a predetermined timing, a current-based value that is based on the current output by the detector,
determine whether or not the current-based value is greater than or equal to a predetermined threshold, and
perform position detection of the hand, based on the determination,
wherein the predetermined timing is earlier than a timing at which the current-based value, which is based on the current output by the detector, becomes a value in a steady state.

16. The storage medium according to claim 15, wherein the current-based value obtained at the predetermined timing is a value temporarily amplified by an electric charge stored in a parasitic capacity by light hitting the detector.

17. The storage medium according to claim 16, wherein an afterglow effect removal pulse that resets the parasitic capacity is input to the detector before the voltage is applied to the detector.

18. The storage medium according to claim 15, wherein:
the predetermined timing is earlier than the timing at which the current-based value becomes the value in the steady state, and
the predetermined timing is a predetermined time after the voltage is applied to the detector.

19. The storage medium according to claim 15, wherein:
the electronic timepiece further includes a light emitter that is disposed to face the detector and configured to emit light toward the detector, and
in the position detection of the hand, the light emitter is turned on before the voltage is applied to the detector.

20. The storage medium according to claim 19, wherein the voltage is applied to the detector a predetermined time after the light emitter is turned on.
